(19) United States
(12) Patent Application Publication
(10) Pub. No.: US 2026/0121742 A1
(43) Pub. Date: Apr. 30, 2026

(54) Method and Apparatus for Establishing PCIe Optical Interconnection Link, Device, Medium, and System

(71) Applicant: SUZHOU METABRAIN INTELLIGENT TECHNOLOGY CO.,LTD., Suzhou, Jiangsu (CN)

(72) Inventors: Weikang ZHAO, Suzhou, Jiangsu (CN); Caikun YANG, Suzhou, Jiangsu (CN); Xianyang GAO, Suzhou, Jiangsu (CN); Tanlong CI, Suzhou, Jiangsu (CN)

(73) Assignee: SUZHOU METABRAIN INTELLIGENT TECHNOLOGY CO.,LTD., Suzhou, Jiangsu (CN)

(21) Appl. No.: 19/161,038

(22) PCT Filed: Jan. 3, 2024
(86) PCT No.: PCT/CN2024/070455

§ 371 Date: Aug. 29, 2025

(30) Foreign Application Priority Data
Jun. 28, 2023 (CN) 202310771673.6

(51) Int. Cl. H04B 10/038; H04B 10/079; H04B 10/278

(52) U.S. Cl. CPC H04B 10/038; H04B 10/0795; H04B 10/278

(57) ABSTRACT

Disclosed are a method and apparatus for establishing a Peripheral Component Interconnect Express (PCIe) optical interconnection link, a device, a non-volatile readable storage medium, and a system. The method includes: acquiring an upstream data signal transmitted through an electrical path, and detecting whether at least one Electrical Idle Ordered Set (EIOS) exists in the upstream data signal; recording a current link rate of the PCIe optical interconnection link, and determining whether the transmission of the at least one EIOS is completed by counting the at least one EIOS; and generating a target signal sequence of a corresponding rate according to the current link rate in a case where the transmission of the at least one EIOS is completed, and transmitting the target signal sequence to an opposite end through the PCIe optical interconnection link.

### CROSS-REFERENCE TO RELATED APPLICATION

This present disclosure claims priority to Chinese Patent Application No. 202310771673.6, filed to the China National Intellectual Property Administration on Jun. 28, 2023 and entitled “Method and Apparatus for Establishing PCIe Optical Interconnection Link, Device, Medium, and System”, the disclosure of which is hereby incorporated by reference in its entirety.

### Technical Field

The present disclosure relates to the technical field of signal transmission, and in particular to a method and an apparatus for establishing a Peripheral Component Interconnect Express (PCIe) optical interconnection link, a device, a non-volatile readable storage medium, and a system.

### BACKGROUND

PCIe is a high-speed serial computer expansion bus standard, which is mainly configured to expand the data throughput of computer system buses and improve the communication speed of devices. At present, transmission paths of PCIe data signals are mainly constructed by means of electrical interconnections, such as Printed Circuit Board (PCB)-level copper wires and copper cables. With the continuous update of a PCIe protocol, the loss caused by the electrical interconnection has become increasingly prominent, and the signal transmission distance achieved by the electrical interconnection has gradually decreased. At this time, low-loss optical interconnection is a priority solution. However, since the corresponding standards of optical modules are not formulated for the PCIe protocol, some settings in the PCIe protocol are incompatible with the existing optical module standards. The main problem is that a receiving end of the optical module needs a period of time to operate stably when receiving a burst signal, and a back end cannot extract a clock signal from data during this period of time before stable operation, that is, a link establishment failure may be caused by an Electrical Idle (EI) state in the process of PCIe optical interconnection link establishment. Therefore, how to establish a PCIe optical interconnection link is an urgent problem to be solved.

### SUMMARY

In view of this, an objective of the present disclosure is to provide a method and an apparatus for establishing a PCIe optical interconnection link, a device, and a non-volatile readable storage medium, which can establish the PCIe optical interconnection link and increase the success rate of establishing the PCIe optical interconnection link. The specific solution is as follows.

In a first aspect, the present disclosure discloses a method for establishing a PCIe optical interconnection link, which is applied to a pre-created bypass module and includes the following operations:
acquiring an upstream data signal transmitted by means of an electrical path, and it is detected whether at least one Electrical Idle Ordered Set (EIOS) exists in the upstream data signal;
in a case where the at least one EIOS exists in the upstream data signal, recording a current link rate of the PCIe optical interconnection link, and determining whether the current transmission of the at least one EIOS is completed by counting the at least one EIOS;
generating a target signal sequence of a corresponding rate according to the current link rate in a case where the transmission of the at least one EIOS is completed, and transmitting the target signal sequence to an opposite end through the PCIe optical interconnection link, so that the opposite end maintains stable operation based on the target signal sequence.

Optionally, the recording a current link rate of the PCIe optical interconnection link includes the following operation:
determining the current link rate of the PCIe optical interconnection link according to a transmitting rate of the at least one EIOS, and recording the current link rate.

Optionally, determining whether the transmission of the at least one EIOS is completed by counting the at least one EIOS includes the following operations:
counting the at least one EIOS is counted. The at least one EIOS is configured to indicate that a transmitting end is about to enter an EI state;
determining that the transmission of the at least one EIOS is completed When a count value reaches a target value set by a PCIe protocol, determining the transmission of the at least one EIOS is not completed when the count value does not reach the target value.

Optionally, after detecting whether the at least one EIOS exists in the upstream data signal, the method further includes the following operation:
in a case where it is detected that the at least one EIOS does not exist in the upstream data signal, transmitting the upstream data signal through the PCIe optical interconnection link directly;
after determining whether the transmission of the at least one EIOS is completed by counting the at least one EIOS, the method further includes the following operation:
in a case where it is determined that the transmission of the at least one EIOS is not completed, transmitting the upstream data signal through the PCIe optical interconnection link directly.

Optionally, the generating the target signal sequence of a corresponding rate according to the current link rate includes the following operation:
determining a target rate based on the link rate according to a preset increasing and decreasing range, and generating the target signal sequence according to the target rate.

Optionally, the transmitting the target signal sequence to an opposite end through the PCIe optical interconnection link includes the following operation:
after performing electro-optical conversion on the target signal sequence by a local optical transmitting assembly to obtain an optical signal, transmitting the optical signal to an optical receiving assembly at the opposite end through the PCIe optical interconnection link.

Optionally, maintaining, by the opposite end, stable operation based on the target signal sequence includes the following operation:
performing, by the optical receiving assembly at the opposite end, photoelectric conversion on a received optical signal to obtain the target signal sequence, and forwarding the target signal sequence to a termination device in the bypass module at the opposite end, so that a Trans-Impedance Amplifier (TIA) in an optical module at the opposite end maintains stable operation.

Optionally, the performing, by the optical receiving assembly at the opposite end, photoelectric conversion on a received optical signal to obtain the target signal sequence includes the following operations:
performing, by the optical receiving assembly at the opposite end, photoelectric conversion on the received optical signal to obtain an electrical signal;
detecting whether the target signal sequence exists in the electrical signal;
in a case where the target signal sequence exists, jumping to the step of forwarding the target signal sequence to the termination device in the bypass module at the opposite end.

Optionally, after detecting whether the target signal sequence exists in the electrical signal, the method further includes the following operation:
in a case where the target signal sequence does not exist in the electrical signal, forwarding the electrical signal to a terminal device directly.

Optionally, before detecting whether the target signal sequence exists in the electrical signal, the method further includes the following operations:
detecting whether the at least one EIOS exists in the electrical signal;
in a case where the at least one EIOS does not exist, jumping to the step of detecting whether the target signal sequence exists in the electrical signal.

Optionally, after detecting whether the at least one EIOS exists in the electrical signal, the method further includes the following operations:
in a case where the at least one EIOS exists in the electrical signal, determining the current link rate according to the at least one EIOS, and recording the current link rate;
counting the at least one EIOS, and determining whether the transmission of the at least one EIOS is completed according to a count value of the at least one EIOS;
in a case where the transmission of the at least one EIOS is completed, preparing to receive the target signal sequence.

Optionally, after determining whether the transmission of the at least one EIOS is completed according to the count value, the method further includes the following operation:
in a case where the transmission of the at least one EIOS is not completed, forwarding the electrical signal to a terminal device directly.

Optionally, the bypass module, a local optical transmitting assembly and an optical receiving assembly are integrated in the optical module.

Optionally, the bypass module, as an independent device, is respectively connected to a host and the optical module.

Optionally, the bypass module is integrated in a PCIe signal repeater, and the PCIe signal repeater is respectively connected to a host and the optical module.

Optionally, the bypass module includes a pattern generator, a data signal gate, a pattern detection controller, and the termination device;
the pattern detection controller is configured to acquire the upstream data signal transmitted through the electrical path, detect whether the at least one EIOS exists in the upstream data signal, record the current link rate, determine whether the transmission of the at least one EIOS is completed by counting the at least one EIOS, control data transmission of the data signal gate, and control the pattern generator to generate a pattern;
the pattern generator is configured to generate the target signal sequence of the corresponding rate according to the current link rate;
the data signal gate is configured to acquire the upstream data signal transmitted through the electrical path, and transmit the target signal sequence to the opposite end through the PCIe optical interconnection link;
the termination device is configured to store the target signal sequence transmitted by the opposite end.

Optionally, the pattern detection controller is further configured to receive an electrical signal transmitted by the opposite end and obtained by performing photoelectric conversion by the optical receiving assembly, and control a signal transmission channel of the data signal gate.

The data signal gate is further configured to receive the electrical signal transmitted by the opposite end and obtained by performing photoelectric conversion by the optical receiving assembly, forward the electrical signal to the termination device in a case where the electrical signal is the target signal sequence, and forward the electrical signal to a terminal device in a case where the electrical signal is not the target signal sequence.

Optionally, the pattern detection controller supports identifying patterns related to an EI state in a process of training the PCIe optical interconnection link.

Optionally, signal rates supported by the data signal gate comprise signal rates specified by the PCIe protocol.

In a second aspect, the present disclosure discloses an apparatus for establishing a PCIe optical interconnection link, which includes a detection module, a recording module, and a sequence sending module.
the detection module is configured to acquire an upstream data signal transmitted through an electrical path, and detect whether an at least one EIOS exists in the upstream data signal.

The recording module is configured to, in a case where the at least one EIOS exists in the upstream data signal, record a current link rate, and determine whether the transmission of the at least one EIOS is completed by counting the at least one EIOS.

The sequence sending module is configured to generate a target signal sequence of a corresponding rate according to the current link rate in a case where the transmission of the at least one EIOS is completed, and transmit the target signal sequence to an opposite end through the PCIe optical interconnection link, so that the opposite end maintains stable operation based on the target signal sequence.

In a third aspect, the present disclosure discloses an electronic device, which includes a memory and a processor.

The memory is configured to store a computer program.

The processor is configured to execute the computer program to implement the abovementioned method for establishing the PCIe optical interconnection link.

In a fourth aspect, the present disclosure discloses a computer non-volatile readable storage medium, configured to store a computer program. The computer program, when executed by a processor, implements the abovementioned method for establishing the PCIe optical interconnection link.

In a fifth aspect, the present disclosure discloses a PCIe optical interconnection link system, which includes a host, an optical module, and the abovementioned bypass module. The bypass module includes a pattern generator, a data signal gate, a pattern detection controller, and a termination device.

The data signal gate is respectively connected to the host, an optical transmitting assembly and an optical receiving assembly in the optical module, the pattern generator, and the termination device.

The pattern detection controller is respectively connected to the host, the data signal gate, the optical receiving assembly, and the pattern generator.

In the present disclosure, the upstream data signal transmitted through the electrical path is acquired, and it is detected whether the at least one EIOS exists in the upstream data signal. in a case where the at least one EIOS exists in the upstream data signal, the current link rate is recorded, and it is determined whether the transmission of the at least one EIOS is completed by counting the at least one EIOS. In a case where the transmission of the at least one EIOS is completed, the target signal sequence of the corresponding rate is generated according to the link rate, and the target signal sequence is transmitted to the opposite end through the PCIe optical interconnection link, so that the opposite end maintains stable operation based on the target signal sequence.

It can be seen that, by means of determining whether the link is about to enter the EI state according to the EIOS, and after entering the EI state, maintaining operating states of the local end and the receiving end by means of generating the target signal sequence of the corresponding rate, the impact of a burst signal on the TIA can be avoided, and the PCIe link can be established between the host such as a server and an external device through an optical fiber, thereby avoiding the problem of a link establishment failure caused by the EI state in the process of PCIe optical interconnection link establishment, that is, solving the problem that the interconnection link has a burst mode from no data transmission to high-speed data signal transmission when the link exits the EI state.

### BRIEF DESCRIPTION OF THE DRAWINGS

In order to more clearly illustrate the embodiments of the present disclosure or the technical solutions in the related art, the drawings used in the description of the embodiments or the related art will be briefly described below. It is apparent that the drawings described below are only embodiments of the present disclosure. Other drawings may further be obtained by those of ordinary skill in the art according to these drawings without creative efforts.

FIG. 1 is a flowchart of a method for establishing a PCIe optical interconnection link provided by the present disclosure.

FIG. 2 is a schematic structural diagram of an optional bypass module provided by the present disclosure.

FIG. 3 is a flowchart of an optional PCIe optical interconnection method at a transmitting end provided by the present disclosure.

FIG. 4 is a flowchart of an optional PCIe optical interconnection method at a receiving end provided by the present disclosure.

FIG. 5 is a schematic structural diagram of an optional PCIe optical interconnection system provided by the present disclosure.

FIG. 6 is a schematic structural diagram of another optional PCIe optical interconnection system provided by the present disclosure.

FIG. 7 is a schematic structural diagram of another optional PCIe optical interconnection system provided by the present disclosure.

FIG. 8 is a schematic structural diagram of an apparatus for establishing a PCIe optical interconnection link provided by the present disclosure.

FIG. 9 is a structural diagram of an electronic device provided by the present disclosure.

### DETAILED DESCRIPTION OF THE EMBODIMENTS

In order to make the objectives, technical solutions and advantages of the embodiments of the present disclosure clearer, the technical solutions in the embodiments of the present disclosure will be clearly and completely described in conjunction with the drawings in the embodiments of the present disclosure. It is apparent that the described embodiments are only a part of the embodiments of the present disclosure, and not all of them. All other embodiments obtained by those of ordinary skill in the art on the basis of the embodiments in the present disclosure without creative work shall fall within the scope of protection of the present disclosure.

In the related art, since the corresponding standards of optical modules are not formulated for a PCIe protocol, some settings in the PCIe protocol are incompatible with the existing optical module standards. The main problem is that a receiving end of the optical module needs a period of time to operate stably when receiving a burst signal, and a back end cannot extract a clock signal from data during this period of time before stable operation, that is, the optical module cannot cope with the sudden high-speed signal transmission after an EI state, thereby causing a failure of constructing a PCIe optical interconnection path directly using the optical module. In order to overcome the above technical problems, the present disclosure provides a method for establishing a PCIe optical interconnection link, which can establish the PCIe optical interconnection link, and increase the success rate of establishing the PCIe optical interconnection link, thereby avoiding the problem of a link establishment failure caused by the EI state in the process of PCIe optical interconnection link establishment.

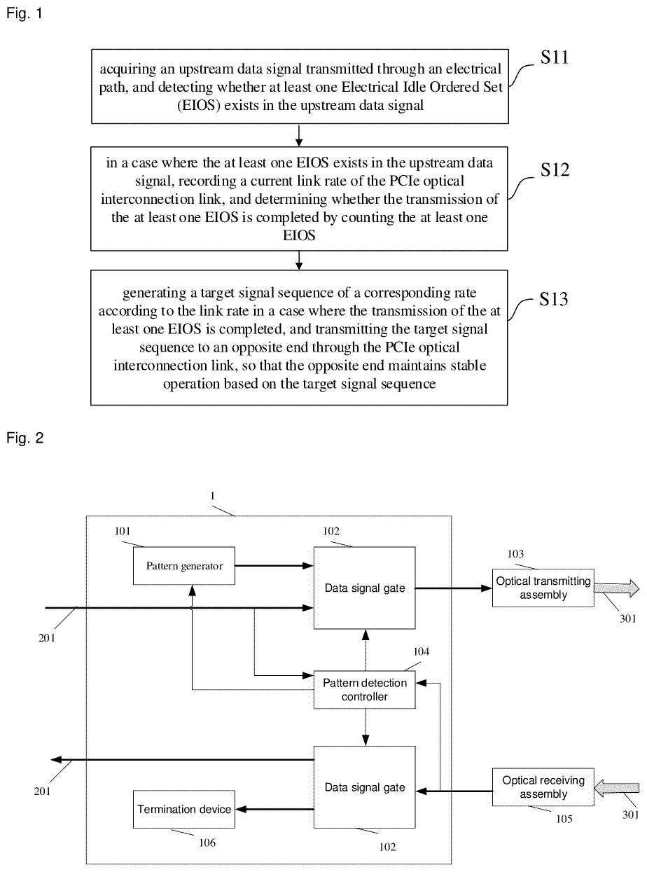

The embodiments of the present disclosure disclose a method for establishing a PCIe optical interconnection link, as shown in FIG. 1, which is applied to a pre-created bypass module. The method may include the following steps.

At S11, an upstream data signal transmitted through an electrical path is acquired, and it is detected whether at least one EIOS exists in the upstream data signal.

In the present embodiment, the upstream data signal transmitted through the electrical path is first acquired, and then it is detected whether the at least one EIOS exists in the upstream data signal. It is understandable that, a link training process exists in the process of PCIe interconnection link establishment, and the entire interconnection link needs to correctly transmit signals in the process of link training to successfully establish the link. In the process of link training, the link may enter the EI state many times. After entering the EI state, data signal transmission does not exist in the interconnection link. Thereafter, a transmitting end (Tx) may transmit corresponding ordered sets to awaken a receiving end (Rx) to continue the link training process when the data needs to be transmitted. Optionally, before entering the EI state, the transmitting end needs to transmit a plurality of EIOSs defined by the PCIe protocol to the receiving end to enter the EI state. When exiting the EI state, the transmitting end needs to transmit a plurality of Electrical Idle Exit Ordered Sets (EIEOSs) defined by the PCIe protocol to an opposite end device to exit the EI state. Specifically, it is determined whether the EIOS exists in the upstream data signal according to the characteristics of the EIOS defined by the PCIe protocol.

In the present embodiment, after detecting whether the at least one EIOS exists in the upstream data signal, the method may further include that: in a case where it is detected that the at least one EIOS does not exist in the upstream data signal, the upstream data signal is transmitted through the PCIe optical interconnection link directly. That is, in a case where the at least one EIOS does not exist in the upstream data signal, it is proved that the link is in the process of normal data transmission, and at this time, the upstream data signal is directly transmitted to the opposite end through the PCIe optical interconnection link.

At S12, in a case where the at least one EIOS exists in the upstream data signal, a current link rate of the PCIe optical interconnection link is recorded, and it is determined whether the transmission of the at least one EIOS is completed by counting the at least one EIOS.

In the present embodiment, if the EIOS is detected, it indicates that the link prepares to enter an idle state, and at this time, the current link rate is recorded, and it is determined whether the transmission of the at least one EIOS has been completed by counting the at least one EIOS. It is understandable that, in a case where the transmission of the at least one EIOS is completed, it indicates that the link enters the idle state, otherwise it indicates that the link is still in the preparation stage for entering the idle state.

In the present embodiment, the operation that the current link rate of the PCIe optical interconnection link is recorded may include that: determining the current link rate of the PCIe optical interconnection link according to a transmitting rate of the at least one EIOS, and recording the current link rate. The link rate, i.e., the link transmission rate, refers to the speed at which a host or router transmits data to the link, so that the current link rate of the PCIe optical interconnection link may be determined and then recorded according to the transmitting rate of the EIOS.

In the present embodiment, the operation that the determining whether the transmission of the at least one EIOS is completed by counting the at least one EIOS may include that: the at least one EIOS is counted, the at least one EIOS being configured to indicate that the transmitting end is about to enter the EI state; and it is determined that the transmission of the at least one EIOS is completed when a count value of the at least one EIOS reaches a target value set by a PCIe protocol, otherwise it is determined that the transmission of the at least one EIOS is not completed when the count value does not reach the target value. The total number of EIOSs transmitted each time the transmitting end enters the EI state, i.e., the target value set by the above PCIe protocol, is fixed. Therefore, the EIOS is counted, and it is determined whether the current transmitting of the EIOS has been completed according to the count value. When the count value reaches the target value, the current transmitting has been completed, otherwise the current transmitting has not been completed.

In the present embodiment, after determining whether the transmission of the at least one EIOS is completed by counting the at least one EIOS, the method may further include that: in a case where it is determined that the transmission of the at least one EIOS is not completed, the upstream data signal is directly transmitted through the PCIe optical interconnection link. That is, in a case where the transmission of the at least one EIOS has not been completed, it is proved that the link is in the process of EIOS transmission, and at this time, the upstream data signal including the EIOS is directly transmitted to the opposite end through the PCIe optical interconnection link.

At S13, a target signal sequence of a corresponding rate is generated according to the link rate in a case where the transmission of the at least one EIOS is completed, and the target signal sequence is transmitted to an opposite end through the PCIe optical interconnection link, so that the opposite end maintains stable operation based on the target signal sequence.

In the present embodiment, the target signal sequence of the corresponding rate is generated according to the link rate in a case where the transmission of the at least one EIOS is completed, and the target signal sequence is transmitted to the opposite end through the PCIe optical interconnection link, so that the opposite end maintains stable operation by means of continuously receiving the target signal sequence. It is understandable that, the main reason for the link establishment failure caused by the EI state in the process of PCIe optical interconnection link establishment is that the link may store a sudden change in the data rate from the EI state to the normal data transmission state. However, a TIA at a receiving end of an optical module needs a period of time to operate stably when receiving a burst signal, and the TIA cannot accurately convert a front-end photocurrent signal into a correct voltage signal, and cannot extract a clock signal from data during this period of time before stable operation, thereby causing the link establishment failure. In the present embodiment, the TIA is always in a normal operating state by utilizing the target signal sequence, thereby avoiding the problem of the link establishment failure caused by the EI state.

In the present embodiment, the operation that the target signal sequence of the corresponding rate is generated according to the link rate may include that: a target rate is determined based on the link rate according to a preset increasing and decreasing range, and the target signal sequence is generated according to the target rate. That is, the target rate may be obtained by appropriately decreasing or increasing or keeping the link rate unchanged, as long as a difference between the target rate and the link rate is not so large that the TIA needs a period of time to adapt. In some cases, the lowest rate may be selected within the allowable range, which can not only avoid the problem of the link establishment failure, but also save the resources.

In the present embodiment, the operation that the target signal sequence is transmitted the target signal sequence to the opposite end through the PCIe optical interconnection link may include that: after performing electro-optical conversion on the target signal sequence by a local optical transmitting assembly to obtain an optical signal, the optical signal is transmitted to an optical receiving assembly at the opposite end through the PCIe optical interconnection link. That is, an electrical signal of the target signal sequence is converted into an optical signal by utilizing the optical transmitting assembly, and the optical signal is transmitted to the opposite end through an optical fiber. It is to be understood that the local end and the opposite end in the present embodiment are only described from different angles, as are the transmitting end and the receiving end, but each terminal corresponds to the same bypass module for implementing the above steps.

In the related art, there is also a manner of using a Clock Data Recovery (CDR) circuit, which may send a local reference clock as input data to a phase adjustment module when facing the burst signal to ensure that a CDR module may recover the correct clock signal. Although the working condition of correctly recovering the clock data when the data signal is disordered is solved to a certain extent, the problem of stability caused by the inability of the TIA to respond quickly in a burst mode is still faced, ultimately causing the link establishment failure in the process of link training. In the present embodiment, by means of detecting an EIOS that marks the entry into the EI state in the process of link training at the transmitting end, and utilizing the generated target signal sequence of the corresponding rate, it is ensured that an optical link composed of the optical module and the optical fiber always maintains an active state of high-speed transmission before entering the EI state when the transmitting end and the receiving end of the link enter the EI state, thereby avoiding a burst signal transmission mode of entering the normal data transmission state from the EI state at the receiving end, maintaining the TIA at the receiving end of the optical module always in a stable operating mode, completing the link training process, and establishing the PCIe optical interconnection link between the transmitting end and the receiving end.

In the present embodiment, the operation that the opposite end maintains stable operation based on the target signal sequence may include that: the optical receiving assembly at the opposite end performs photoelectric conversion on the received optical signal to obtain the target signal sequence, and forwards the target signal sequence to a termination device in a bypass module at the opposite end, so that the TIA in an optical module at the opposite end maintains stable operation. That is, after photoelectric conversion, the target signal sequence is extracted from the electrical signal, and the TIA at the opposite end may continue to operate according to the target signal sequence.

In the present embodiment, the operation that the optical receiving assembly at the opposite end performs photoelectric conversion on the received optical signal to obtain the target signal sequence includes that: the optical receiving assembly at the opposite end performs photoelectric conversion on the received optical signal to obtain the electrical signal; it is detected whether the target signal sequence exists in the electrical signal; in a case where the target signal sequence exists, jumping to the step of forwarding the target signal sequence to the termination device in the bypass module at the opposite end; and if the target signal sequence does not exist, the electrical signal is directly forwarded to the terminal device. That is, it is first detected whether the target signal sequence exists. If the target signal sequence does not exist, normal data information or the EIOS may exist and then be directly transmitted to the terminal device.

In the present embodiment, before detecting whether the target signal sequence exists in the electrical signal, the method further includes that: it is detected whether the at least one EIOS exists in the electrical signal; in a case where the at least one EIOS does not exist in the electrical signal, jumping to the step of detecting whether the target signal sequence exists in the electrical signal; in a case where the at least one EIOS exists in the electrical signal, the current link rate is determined and recorded according to the at least one EIOS; the at least one EIOS is counted, and it is determined whether the transmission of the at least one EIOS is completed according to a count value of the at least one EIOS; in a case where the transmission of the at least one EIOS is completed, the target signal sequence is prepared to be received; and in a case where the transmission of the at least one EIOS is not completed, the electrical signal is directly forwarded to the terminal device. That is, since the EIOS may be transmitted before the target signal sequence, the opposite end may first detect the EIOS and then detect the target signal sequence each time the opposite end receives the signal, thereby improving the detection efficiency. In addition, the above method is applicable to optical interconnection link establishment under the Compute Express Link (CXL) protocol specification based on the PCIe5.0 protocol.

As can be seen from the above, in the present embodiment, the upstream data signal transmitted by means of the electrical path is acquired, and it is detected whether the EIOS exists in the upstream data signal. If the EIOS exists, the current link rate is recorded, and it is determined whether the current sending of the EIOS has been completed by means of counting the EIOS. When the current sending of the EIOS has been completed, the target signal sequence of the corresponding rate is generated according to the link rate, and the target signal sequence is transmitted to the opposite end by means of the PCIe optical interconnection link, so that the opposite end maintains stable operation based on the target signal sequence.

It can be seen that, by means of determining whether the link is about to enter the EI state according to the EIOS, and after entering the EI state, maintaining operating states of the local end and the receiving end by means of generating the target signal sequence of the corresponding rate, the impact of the burst signal on the TIA can be avoided, and the PCIe link can be established between the host such as a server and an external device through the optical fiber, thereby avoiding the link establishment failure caused by the EI state in the process of PCIe optical interconnection link establishment, that is, solving the problem that the interconnection link has the burst mode from no data transmission to high-speed data signal transmission when the link exits the EI state.

Based on the above embodiments, the present disclosure further provides an optional bypass module structure. The bypass module includes a pattern generator, a data signal gate, a pattern detection controller, and a termination device. The pattern detection controller is configured to acquire an upstream data signal transmitted through an electrical path, detect whether the at least one EIOS exists in the upstream data signal, record a current link rate, determine whether the transmission of the at least one EIOS is completed by counting the at least one EIOS, control data transmission of the data signal gate, and control the pattern generator to generate a pattern. The pattern generator is configured to generate a target signal sequences of a corresponding rate according to the current link rate. The data signal gate is configured to acquire the upstream data signal transmitted through the electrical path, and transmit the target signal sequence to an opposite end through the PCIe optical interconnection link. The termination device is configured to store the target signal sequence transmitted by the opposite end.

For example, as shown in FIGS. 2, 1 is a bypass module, 101 is the pattern generator, 102 is the data signal gate, 103 is an optical transmitting assembly, 104 is the pattern detection controller, 105 is an optical receiving assembly, 106 is the termination device, 201 is the electrical path connected to the bypass module, and 301 is an optical fiber connected to the optical transmitting assembly and the optical receiving assembly. When a device sends a signal through the optical fiber 301, the bypass module 1 receives the upstream signal by means of a receiving path (Rx) of the electrical path 201, the received signal enters the data signal gate 102 and the pattern detection controller 104, the pattern detection controller 104 controls the pattern generator 101 and the data signal gate 102, and then the signal output by the data signal gate 102 is converted into an optical signal by means of the optical transmitting assembly 103, and finally transmitted to the outside through the optical fiber 301.

In the present embodiment, the pattern detection controller is further configured to receive an electrical signal transmitted by the opposite end and obtained by performing photoelectric conversion by the optical receiving assembly, and control a signal transmission channel of the data signal gate. The data signal gate is further configured to receive the electrical signal transmitted by the opposite end and obtained by performing photoelectric conversion by the optical receiving assembly, forward the electrical signal to the termination device in a case where the electrical signal is the target signal sequence, and forward the electrical signal to a terminal device in a case where the electrical signal is not the target signal sequence. That is, when the device receives the signal through the optical fiber 301, the received signal is input to the data signal gate 102 and the pattern detection controller 104 after being subjected to photoelectric conversion by means of the optical receiving assembly 105, and the pattern detection controller 104 controls the data signal gate 102 to transmit the input signal to the terminal device 106 or transmit the input signal by means of the electrical path 201.

In the present embodiment, the pattern detection controller supports identifying a pattern related to an EI state in a process of training the PCIe optical interconnection link. That is, the pattern detection controller 104 needs to identify the EI-related patterns in the process of PCIe link training, including, but are not limited to, an Application-Specific Integrated Circuit (ASIC) chip, an Advanced RISC Machines (ARM) processor chip, or a Field-Programmable Gate Array (FPGA) chip, etc., to implement the functions of pattern detection and control of the data signal gate.

In the present embodiment, signal rates supported by the data signal gate comprise signal rates specified by a PCIe protocol. That is, the data signal gate 102 is configured to implement selective signal passing, and the supported signal rates need to cover the signal rates specified by the PCIe protocol, including, but are not limited to, the ASIC chip, the ARM chip, or the FPGA chip, etc., to implement the function of signal gating.

In the present embodiment, the pattern generator 101 may generate the patterns compliant with the rates specified by the PCIe protocol, including, but are not limited to, the ASIC chip, the ARM chip, or the FPGA chip, etc., to maintain the normal operation of an optical module at a receiving end.

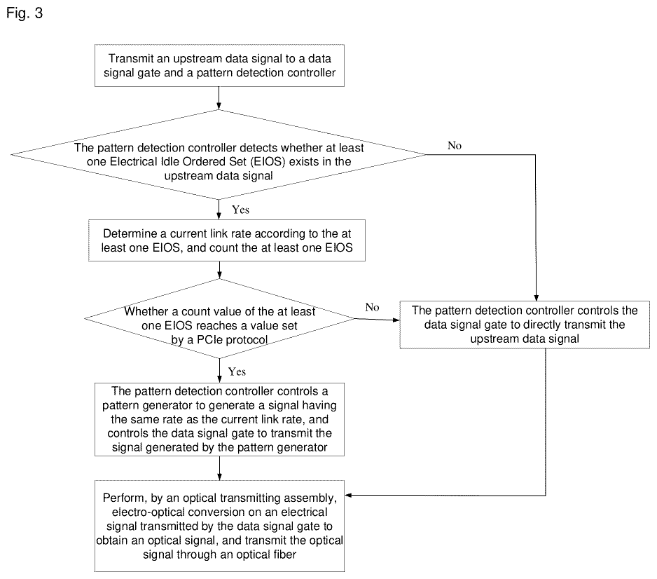

Based on the above embodiments, the present disclosure further provides an optional PCIe optical interconnection method at a transmitting end, for example, as shown in FIG. 3, the method includes the following steps.
1. An upstream data signal is first transmitted to a data signal gate and a pattern detection controller inside a bypass module.
2. The pattern detection controller detects whether at least one Electrical Idle Ordered Set (EIOS) exists in the upstream data signal. In a case where the pattern detection controller detects that the at least one EIOS exists in the upstream signal, it indicates that the transmitting end is about to enter an EI state, and at this time, the pattern detection controller needs to determine a current link rate according to the at least one EIOS and count the at least one EIOS. In a case where the pattern detection controller detects that the at least one EIOS does not exist in the upstream signal, it indicates that the transmitting end does not enter the EI state, and the pattern detection controller controls the data signal gate to directly transmit the upstream data signal.
3. In a case where the at least one EIOS reaches a value set by a PCIe protocol, it indicates that the transmitting end and a receiving end enter the EI state after completing the sending and reception of the current EIOS. After first directly transmitting the last EIOS by means of the data signal gate, the pattern detection controller controls a pattern generator to generate a signal having the same rate as the current link rate. The data signal gate is controlled to transmit the signal generated by the pattern generator to ensure that the link still has high-speed signal transmission.
4. In a case where the at least one EIOS does not reach the number set by the PCIe protocol, an opposite end device needs to wait for the EIOS at the transmitting end several times before entering the EI state, the pattern detection controller controls the data signal gate to directly transmit the upstream data signal, where the data signal at this time is the EIOS.
5. Finally, Perform, by an optical transmitting assembly, electro-optical conversion on an electrical signal transmitted by the data signal gate to obtain an optical signal, and transmit the optical signal through an optical fiber.

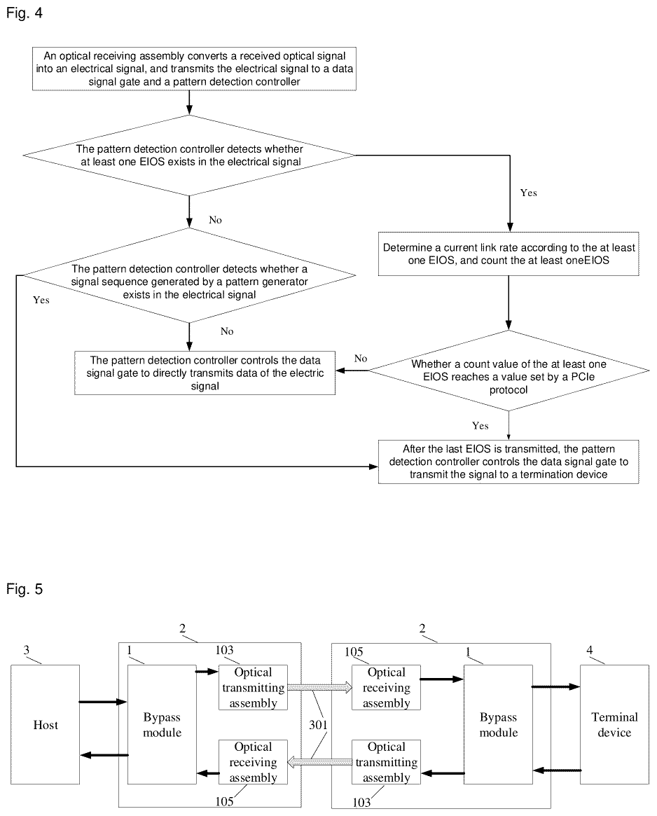

Based on the above embodiments, the present disclosure further provides an optional PCIe optical interconnection method at a receiving end, for example, as shown in FIG. 4, the method includes the following steps.
1. First, an optical receiving assembly converts a received optical signal into an electrical signal and transmits the electrical signal to a data signal gate and a pattern detection controller.
2. The pattern detection controller detects whether at least one EIOS and a signal sequence generated by the pattern generator exist in the electrical signal. In a case where the pattern detection controller detects that the at least one EIOS and the signal sequence generated by the pattern generator do not exist in the electrical signal, it indicates that a transmitting end is in a normal link training state or a normal data transmission state, and the pattern detection controller controls the data signal gate to directly transmit data of the electric signal.
3. In a case where the pattern detection controller detects that the at least one EIOS exists in the electrical signal, it indicates that the transmitting end is about to enter an EI state, and at this time, the pattern detection controller needs to determine a current link rate according to the at least one EIOS and count the at least one EIOS.
4. In a case where the at least one EIOS reaches a value set by a PCIe protocol, it indicates that the transmitting end has been entered the EI state and no longer transmits a training sequence or data, and at this time, the pattern detection controller controls the data signal gate to transmit the signal to a termination device after transmitting the last EIOS.

Accordingly, the embodiments of the present disclosure further disclose a PCIe optical interconnection link system, which includes a host, an optical module, and the abovementioned bypass module. The bypass module includes a pattern generator, a data signal gate, a pattern detection controller, and a termination device.

The data signal gate is respectively connected to the host, an optical transmitting assembly and an optical receiving assembly in the optical module, the pattern generator, and the termination device.

The pattern detection controller is respectively connected to the host, the data signal gate, the optical receiving assembly, and the pattern generator.

In the present embodiment, the bypass module is integrated with the local optical transmitting assembly and the optical receiving assembly within the optical module. For example, FIG. 5 shows a schematic structural diagram of a PCIe optical interconnection system constructed by an optional apparatus for establishing a PCIe optical interconnection link. The bypass module 1 is integrated with the optical transmitting assembly 103 and the optical receiving assembly 105 within the optical module 2. A chip directly connected to a server host and the bypass module 1 may be a Central Processing Unit (CPU), PCIe Switch, PCIe Retimer, etc. A chip or device directly connected to a terminal device and the bypass module 1 may be a Graphics Processing Unit (GPU), a Solid State Drive (SSD), a Dynamic Random Access Memory (DRAM), PCIe Switch, PCIe Retimer, PCIe Redriver, etc.

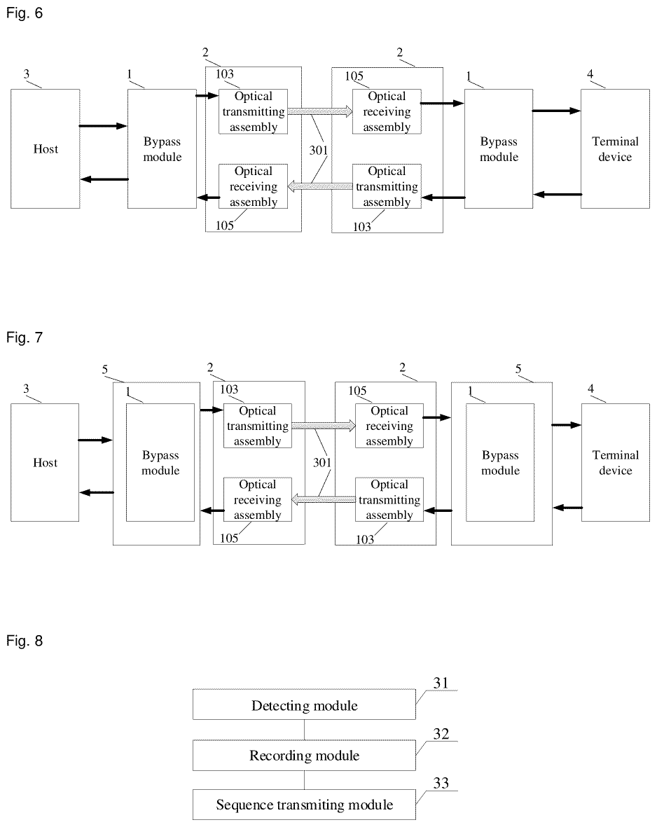

In the present embodiment, the bypass module may further be respectively connected to the host and the optical module as an independent device. For example, FIG. 6 shows a schematic structural diagram of a PCIe optical interconnection system constructed by an optional apparatus for establishing a PCIe optical interconnection link. The bypass module 1 is located between the host and the optical module 2 as an independent device. The chip directly connected to the server host and the bypass module 1 may be the CPU, PCIe Switch, PCIe Retimer, etc. The chip or device directly connected to the terminal device and the bypass module 1 may be the GPU, the SSD, the DRAM, PCIe Switch, PCIe Retimer, PCIe Redriver, etc.

In the present embodiment, the bypass module may further be integrated in a PCIe signal repeater, and the PCIe signal repeater is respectively connected to the host and the optical module. For example, FIG. 7 shows a schematic structural diagram of a PCIe optical interconnection system constructed by an optional apparatus for establishing a PCIe optical interconnection link. The bypass module 1 is integrated into three types of PCIe signal repeater devices 5: PCIe Switch, PCIe Retimer, and PCIe Redriver. A core chip directly connected to the server host and the PCIe signal repeater device 5 may be the CPU, etc. The chip or device directly connected to the terminal device and the PCIe signal repeater device 5 may be the GPU, the SSD, the DRAM, PCIe Switch, PCIe Retimer, PCIe Redriver, etc.

It can be seen that the integration form of the bypass module is also relatively flexible. The bypass module may be placed between the host and the optical module as a separate device, or may be integrated into the chip such as the optical module or the PCIe signal repeater.

Accordingly, the embodiments of the present disclosure further disclose an apparatus for establishing a PCIe optical interconnection link, as shown in FIG. 8, the apparatus includes a detection module 31, a recording module 32, and a sequence sending module 33.

The detection module 31 is configured to acquire an upstream data signal transmitted through an electrical path, and detect whether an at least one EIOS exists in the upstream data signal.

The recording module 32 is configured to, in a case where the at least one EIOS exists in the upstream data signal, record a current link rate, and determine whether the transmission of the at least one EIOS is completed by counting the at least one EIOS.

The sequence sending module 33 is configured to, generate a target signal sequence of a corresponding rate according to the current link rate in a case where the transmission of the at least one EIOS is completed, and transmit the target signal sequence to an opposite end through the PCIe optical interconnection link, so that the opposite end maintains stable operation based on the target signal sequence.

As can be seen from the above, the upstream data signal transmitted by means of the electrical path is acquired, and it is detected whether the EIOS exists in the upstream data signal. If the EIOS exists, the current link rate is recorded, and it is determined whether the current sending of the EIOS has been completed by means of counting the EIOS. When the current sending of the EIOS has been completed, the target signal sequence of the corresponding rate is generated according to the link rate, and the target signal sequence is transmitted to the opposite end by means of the PCIe optical interconnection link, so that the opposite end maintains stable operation based on the target signal sequence.

It can be seen that, by means of determining whether the link is about to enter the EI state according to the EIOS, and after entering the EI state, maintaining operating states of the local end and the receiving end by means of generating the target signal sequence of the corresponding rate, the impact of the burst signal on the TIA can be avoided, and the PCIe link can be established between the host such as a server and an external device through the optical fiber, thereby avoiding the link establishment failure caused by the EI state in the process of PCIe optical interconnection link establishment, that is, solving the problem that the interconnection link has the burst mode from no data transmission to high-speed data signal transmission when the link exits the EI state.

In some optional embodiments, the recording module 32 may specifically include a link rate determination unit.

The link rate determination unit is configured to determine the current link rate of the PCIe optical interconnection link according to a transmitting rate of the at least one EIOS, and recording the current link rate.

In some optional embodiments, the recording module 32 may specifically include a counting unit and a determination unit.

The counting unit is configured to count the at least one EIOS. The at least one EIOS is configured to indicate that a transmitting end is about to enter an EI state.

The determination unit is configured to, determine that the transmission of the at least one EIOS is completed when a count value of the at least one EIOS reaches a target value set by a PCIe protocol, and otherwise determine that the transmission of the at least one EIOS is not completed when the count value does not reach the target value.

In some optional embodiments, the apparatus for establishing the PCIe optical interconnection link may specifically include a first direct transmission unit and a second direct transmission unit.

The first direct transmission unit is configured to, after detecting whether the at least one EIOS exists in the upstream data signal, in a case where it is determined that the at least one EIOS does not exist in the upstream data signal, directly transmit the upstream data signal through the PCIe optical interconnection link.

The second direct transmission unit is configured to, in a case where it is determined that the transmission of the at least one EIOS is not completed, directly transmit the upstream data signal through the PCIe optical interconnection link.

In some optional embodiments, the sequence sending module 33 may specifically include a rate determination unit.

The rate determination unit is configured to determine a target rate based on the link rate according to a preset increasing and decreasing range, and generate the target signal sequence according to the target rate.

In some optional embodiments, the sequence sending module 33 may specifically include a sequence sending unit.

The sequence sending unit is configured to, after performing electro-optical conversion on the target signal sequence by a local optical transmitting assembly to obtain an optical signal, transmit the optical signal to an optical receiving assembly at the opposite end through the PCIe optical interconnection link.

In some optional embodiments, the apparatus for establishing the PCIe optical interconnection link may specifically include a target signal sequence acquisition unit.

The target signal sequence acquisition unit is configured to perform, by an optical receiving assembly at the opposite end, photoelectric conversion on a received optical signal to obtain the target signal sequence, and forward the target signal sequence to a termination device in the bypass module at the opposite end, so that a TIA in an optical module at the opposite end maintains stable operation.

In some optional embodiments, the target signal sequence acquisition unit may specifically include an electrical signal acquisition unit, a target signal sequence detection unit, and an execution unit.

The electrical signal acquisition unit is configured to perform, by the optical receiving assembly at the opposite end, photoelectric conversion on the received optical signal to obtain an electrical signal.

The target signal sequence detection unit is configured to detect whether the target signal sequence exists in the electrical signal.

The execution unit is configured to, in a case where the target signal sequence exists in the electrical signal, perform the step of forwarding the target signal sequence to the termination device in the bypass module at the opposite end.

In some optional embodiments, the target signal sequence acquisition unit may specifically include a forwarding unit.

The forwarding unit is configured to, in a case where the target signal sequence does not exist, directly forward the electrical signal to a terminal device.

In some optional embodiments, the target signal sequence acquisition unit may specifically include an EIOS detection unit.

The EIOS detection unit is configured to, before detecting whether the target signal sequence exists in the electrical signal, detect whether the at least one EIOS exists in the electrical signal.

The execution unit is configured to, in a case where the at least one EIOS does not exist in the electrical signal, jump to the step of detecting whether the target signal sequence exists in the electrical signal.

In some optional embodiments, the target signal sequence acquisition unit may specifically include a recording unit, a determination unit, and a preparation unit.

The recording unit is configured to, in a case where the at least one EIOS exists in the electrical signal, determine the current link rate according to the at least one EIOS, and record the current link rate.

The determination unit is configured to count the at least one EIOS, and determine whether the transmission of the at least one EIOS is completed according to a count value of the at least one EIOS.

The preparation unit is configured to, in a case where the transmission of the at least one EIOS is completed, prepare to receive the target signal sequence.

In some optional embodiments, the target signal sequence acquisition unit may specifically include a forwarding unit.

The forwarding unit is configured to, in a case where the transmission of the at least one EIOS is not completed, directly forward the electrical signal to the terminal device.

In some optional embodiments, the bypass module may specifically be integrated with the local optical transmitting assembly and the optical receiving assembly are integrated in the optical module.

In some optional embodiments, the bypass module, as an independent device, is specifically be respectively connected to the host and the optical module.

In some optional embodiments, the bypass module may specifically be integrated in a PCIe signal repeater, and the PCIe signal repeater is respectively connected to the host and the optical module.

In some optional embodiments, the bypass module may specifically include a pattern generator, a data signal gate, a pattern detection controller, and the termination device.

The pattern detection controller is configured to acquire the upstream data signal transmitted through the electrical path, detect whether the at least one EIOS exists in the upstream data signal, record the current link rate, determine whether the transmission of the at least one EIOS is completed by counting the at least one EIOS, control data transmission of the data signal gate, and control the pattern generator to generate a pattern.

The pattern generator is configured to generate the target signal sequence of the corresponding rate according to the current link rate.

The data signal gate is configured to acquire the upstream data signal transmitted through the electrical path, and transmit the target signal sequence to the opposite end through the PCIe optical interconnection link.

The termination device is configured to store the target signal sequence through by the opposite end.

In some optional embodiments, the pattern detection controller is further configured to receive the electrical signal transmitted by the opposite end after being subjected to photoelectric conversion by means of the optical receiving assembly, and control a signal transmission channel of the data signal gate.

The data signal gate is further configured to receive the electrical signal transmitted by the opposite end and obtained by performing photoelectric conversion by the optical receiving assembly, forward the electrical signal to the termination device in a case where the electrical signal is the target signal sequence, and forward the electrical signal to a terminal device in a case where the electrical signal is not the target signal sequence.

In some optional embodiments, the pattern detection controller supports identifying a pattern related to an EI state in a process of training the PCIe optical interconnection link.

In some optional embodiments, signal rates supported by the data signal gate comprise signal rates specified by the PCIe protocol.

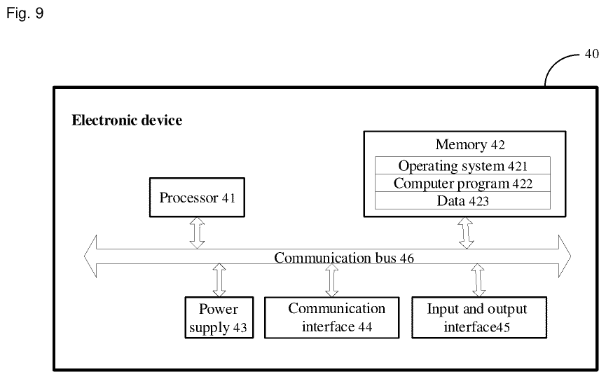

The embodiments of the present disclosure further disclose an electronic device, as shown in FIG. 9, the content illustrated therein cannot be constructed as limiting the scope of application of the present disclosure.

FIG. 9 is a schematic structural diagram of an electronic device 40 provided by an embodiment of the present disclosure. The electronic device 40 may specifically include at least one processor 41, at least one memory 42, a power supply 43, a communication interface 44, an input and output interface 45, and a communication bus 46. The memory 42 is configured to store a computer program, and the computer program is loaded and executed by the processor 41 to implement the relevant steps in the method for establishing the PCIe optical interconnection link disclosed in any of the abovementioned embodiments.

In the present embodiment, the power supply 43 is configured to provide operating voltage for each hardware device on the electronic device 40. The communication interface 44 can create a data transmission channel with an external device for the electronic device 40, and the communication protocol followed is any communication protocol that can be applied to the technical solution of the present disclosure, which is not specifically limited here. The input and output interface 45 is configured to acquire external input data or to output data to the outside, and the specific interface type may be selected according to specific application needs, which is not specifically limited here.

In addition, the memory 42, as a carrier for resource storage, may be a Read-Only Memory (ROM), a Random Access Memory (RAM), a magnetic disk or a Compact Disc (CD), etc., resources stored thereon include an operating system 421, a computer program 422, data 423 including an upstream data signal, etc., and the storage manner may be transient storage or permanent storage.

The operating system 421 is configured to manage and control each hardware device and the computer program 422 on the electronic device 40 to implement the calculation and processing of massive data 423 in the memory 42 by the processor 41, and may be Windows Server, Netware, Unix, Linux, etc. In addition to a computer program that can be configured to complete the method for establishing the PCIe optical interconnection link executed by the electronic device 40 disclosed in any of the abovementioned embodiments, the computer program 422 may further include computer programs that can be configured to store complete other specific tasks.

The embodiments of the present disclosure further disclose a computer non-volatile readable storage medium, in which an executable instruction is stored, and the executable instruction is loaded and executed by a processor to implement the abovementioned method for establishing the PCIe optical interconnection link.

The various embodiments in the present specification are described in a progressive manner, and each embodiment focuses on differences from other embodiments, and the same or similar parts between the various embodiments may be referred to each other. For the apparatus disclosed in the embodiment, since it corresponds to the method disclosed in the embodiment, the description is relatively simple, and the relevant parts can be referred to the method part.

The steps of the method or algorithm described in conjunction with the embodiments disclosed herein may be implemented directly by hardware, a software module executed by a processor, or a combination of the two. The software module may be placed in an RAM, a memory, an RAM, an electrically programmable ROM, an electrically erasable programmable ROM, a register, a hard disk, a removable disk, a CD-ROM, or any other form of non-volatile readable storage medium known in the technical field.

Finally, it is to be noted that relational terms such as first, second, and the like herein are adopted only to distinguish one entity or operation from another entity or operation and not always to require or imply existence of any such practical relationship or sequence between the entities or operations. Furthermore, terms “include” and “contain” or any other variant thereof is intended to cover nonexclusive inclusions herein, so that a process, method, object or device including a series of elements not only includes those elements but also includes other elements which are not clearly listed or further includes elements intrinsic to the process, the method, the object or the device. Under the condition of no more limitations, an element defined by the statement “including a/an . . . ” does not exclude existence of the same other elements in a process, method, object or device including the element.

The method and apparatus for establishing the PCIe optical interconnection link, the device, and the non-volatile computer readable storage medium provided in the present disclosure are described in detail above. The principles and implementations of the present disclosure are described herein using specific examples, the description of the above embodiments are only used to help the understanding of the method and core concept of the present disclosure. At the same time, for those of ordinary skill in the art, according to the concept of the present disclosure, there will be changes in the specific implementations and the scope of application. In summary, the contents of the present description should not be construed as limiting the present disclosure.

1. A method for establishing a Peripheral Component Interconnect Express (PCIe) optical interconnection link, applied to a pre-created bypass module, comprising:
acquiring an upstream data signal transmitted through an electrical path, and detecting whether at least one Electrical Idle Ordered Set (EIOS) exists in the upstream data signal;
in a case where the at least one EIOS exists in the upstream data signal, recording a current link rate of the PCIe optical interconnection link, and determining whether the transmission of the at least one EIOS is completed by counting the at least one EIOS; and
generating a target signal sequence of a corresponding rate according to the current link rate in a case where the transmission of the at least one EIOS is completed, and transmitting the target signal sequence to an opposite end through the PCIe optical interconnection link, so that the opposite end maintains stable operation based on the target signal sequence.

2. The method for establishing the PCIe optical interconnection link according to claim 1, wherein the recording a current link rate of the PCIe optical interconnection link comprises:
determining the current link rate of the PCIe optical interconnection link according to a transmitting rate of the at least one EIOS, and recording the current link rate.

3. The method for establishing the PCIe optical interconnection link according to claim 1, wherein the determining whether the transmission of the at least one EIOS is completed by counting the at least one EIOS comprises:
counting the at least one EIOS, the at least one EIOS being configured to indicate that a transmitting end is about to enter an Electrical Idle (EI) state; and
determining that the transmission of the at least one EIOS is completed when a count value of the at least one EIOS reaches a target value set by a PCIe protocol, determining that the transmission of the at least one EIOS is not completed when the count value does not reach the target value.

4. The method for establishing the PCIe optical interconnection link according to claim 1, wherein after detecting whether the at least one EIOS exists in the upstream data signal, the method further comprises: in a case where it is detected that the at least one EIOS does not exist in the upstream data signal, transmitting the upstream data signal through the PCIe optical interconnection link directly; and
after determining whether the transmission of the at least one EIOS is completed by counting the at least one EIOS, the method further comprises: in a case where it is determined that the transmission of the at least one EIOS is not completed, transmitting the upstream data signal through the PCIe optical interconnection link directly.

5. The method for establishing the PCIe optical interconnection link according to claim 1, wherein the generating a target signal sequence of a corresponding rate according to the current link rate comprises:
determining a target rate based on the link rate according to a preset increasing and decreasing range, and generating the target signal sequence according to the target rate.

6. The method for establishing the PCIe optical interconnection link according to claim 1, wherein the transmitting the target signal sequence to an opposite end through the PCIe optical interconnection link comprises:
after performing electro-optical conversion on the target signal sequence by a local optical transmitting assembly to obtain an optical signal, transmitting the optical signal to an optical receiving assembly at the opposite end through the PCIe optical interconnection link.

7. The method for establishing the PCIe optical interconnection link according to claim 1, wherein maintaining, by the opposite end, stable operation based on the target signal sequence comprises:
performing, by the optical receiving assembly at the opposite end, photoelectric conversion on a received optical signal to obtain the target signal sequence, and forwarding the target signal sequence to a termination device in the bypass module at the opposite end, so that a Trans-Impedance Amplifier (TIA) in an optical module at the opposite end maintains stable operation.

8. The method for establishing the PCIe optical interconnection link according to claim 7, wherein the performing, by the optical receiving assembly at the opposite end, photoelectric conversion on a received optical signal to obtain the target signal sequence comprises:
performing, by the optical receiving assembly at the opposite end, photoelectric conversion on the received optical signal to obtain an electrical signal;
detecting whether the target signal sequence exists in the electrical signal; and
in a case where the target signal sequence exists in the electrical signal, jumping to the step of forwarding the target signal sequence to the termination device in the bypass module at the opposite end.

9. The method for establishing the PCIe optical interconnection link according to claim 8, wherein
after detecting whether the target signal sequence exists in the electrical signal, the method further comprises:
in a case where the target signal sequence does not exist in the electrical signal, forwarding the electrical signal to a terminal device directly;
and/or,
before detecting whether the target signal sequence exists in the electrical signal, the method further comprises: detecting whether the at least one EIOS exists in the electrical signal; and in a case where the at least one EIOS does not exist in the electrical signal, jumping to the step of detecting whether the target signal sequence exists in the electrical signal.

10. (canceled)

11. The method for establishing the PCIe optical interconnection link according to claim 9, wherein after detecting whether the at least one EIOS exists in the electrical signal, the method further comprises:
in a case where the at least one EIOS exists in the electrical signal, determining the current link rate according to the at least one EIOS, and recording the current link rate;
counting the at least one EIOS, and determining whether the transmission of the at least one EIOS is completed according to a count value of the at least one EIOS; and
in a case where the transmission of the at least one EIOS is completed, preparing to receive the target signal sequence.

12. The method for establishing the PCIe optical interconnection link according to claim 11, wherein after determining whether the transmission of the at least one EIOS is completed according to the count value, the method further comprises:
in a case where the transmission of the at least one EIOS is not completed, forwarding the electrical signal to a terminal device directly.

13. The method for establishing the PCIe optical interconnection link of claim 1, wherein
the bypass module, a local optical transmitting assembly and an optical receiving assembly are integrated in an optical module;
and/or,
the bypass module, as an independent device, is respectively connected to a host and an optical module;
and/or,
the bypass module is integrated in a PCIe signal repeater, and the PCIe signal repeater is respectively connected to a host and an optical module.

14. (canceled)

15. (canceled)

16. The method for establishing the PCIe optical interconnection link according to claim 1, any wherein the bypass module comprises a pattern generator, a data signal gate, a pattern detection controller, and a termination device;
the pattern detection controller is configured to acquire the upstream data signal transmitted through the electrical path, detect whether the at least one EIOS exists in the upstream data signal, record the current link rate, determine whether the transmission of the at least one EIOS is completed by counting the at least one EIOS, control data transmission of the data signal gate, and control the pattern generator to generate a pattern;
the pattern generator is configured to generate the target signal sequence of the corresponding rate according to the current link rate;
the data signal gate is configured to acquire the upstream data signal transmitted through the electrical path, and transmit the target signal sequence to the opposite end through the PCIe optical interconnection link; and
the termination device is configured to store the target signal sequence transmitted by the opposite end.

17. The method for establishing the PCIe optical interconnection link according to claim 16, wherein the pattern detection controller is further configured to receive an electrical signal transmitted by the opposite end and obtained by performing photoelectric conversion by the optical receiving assembly, and control a signal transmission channel of the data signal gate; and
the data signal gate is further configured to receive the electrical signal transmitted by the opposite end and obtained by performing photoelectric conversion by the optical receiving assembly, forward the electrical signal to the termination device in a case where the electrical signal is the target signal sequence, and forward the electrical signal to a terminal device in a case where the electrical signal is not the target signal sequence.

18. The method for establishing the PCIe optical interconnection link according to claim 16, wherein the pattern detection controller supports identifying a pattern related to an EI state in a process of training the PCIe optical interconnection link.

19. The method for establishing the PCIe optical interconnection link according to claim 16, wherein signal rates supported by the data signal gate comprise signal rates specified by a PCIe protocol.

20. An apparatus of establishing a Peripheral Component Interconnect Express (PCIe) optical interconnection link, comprising:
a detection module, configured to acquire an upstream data signal transmitted through an electrical path, and detect whether at least one Electrical Idle Ordered Set (EIOS) exists in the upstream data signal;
a recording module, configured to, in a case where the at least one EIOS exists in the upstream data signal, record a current link rate of the PCIe optical interconnection link, and determine whether the transmission of the at least one EIOS is completed by counting the at least one EIOS; and
a sequence sending module, configured to generate a target signal sequence of a corresponding rate according to the current link rate in a case where the transmission of the at least one EIOS is completed, and transmit the target signal sequence to an opposite end through the PCIe optical interconnection link, so that the opposite end maintains stable operation based on the target signal sequence.

21. An electronic device, comprising:
a memory, configured to store a computer program; and
a processor, configured to execute the computer program to implement the method for establishing the Peripheral Component Interconnect Express (PCIe) optical interconnection link according to claim 1.

22. A non-volatile computer readable storage medium, configured to store a computer program, wherein the computer program, when executed by a processor, implements the method for establishing the Peripheral Component Interconnect Express (PCIe) optical interconnection link according to claim 1.

23. A Peripheral Component Interconnect Express (PCIe) optical interconnection link system, comprising a host, an optical module, and the bypass module according to claim 1, the bypass module comprising a pattern generator, a data signal gate, a pattern detection controller, and a termination device;
the data signal gate is respectively connected to the host, an optical transmitting assembly and an optical receiving assembly in the optical module, the pattern generator, and the termination device; and
the pattern detection controller is respectively connected to the host, the data signal gate, the optical receiving assembly, and the pattern generator.
